(19) United States
(12) Patent Application Publication
(10) Pub. No.: US 2001/0013132 A1
(43) Pub. Date: Aug. 9, 2001

(54) Frequency converter for cable television transmitter with simplified configuation

(75) Inventors: Yasuharu Kudo, Fukushima-ken (JP); Etsuya Shibata, Fukushima-ken (JP)

Correspondence Address: BEYER WEAVER & THOMAS LLP, P.O. BOX 778, BERKELEY, CA, 94704-0778, US

(73) Assignee: ALPS ELECTRIC CO., LTD.

(21) Appl. No.: 09/753,790

(22) Filed: Jan. 2, 2001

(30) Foreign Application Priority Data
Feb. 4, 2000 (JP) 2000-024303

(51) Int. Cl. H04B 1/16; H04N 7/173

(52) U.S. Cl. 725/111; 348/731; 455/340

(57) ABSTRACT

The invention provides a frequency converter for a cable television transmitter, which executes frequency conversion with one frequency mixer to simplify the total configuration, to prevent deterioration of the carrier vs. noise ratio, and to effectively remove spurious frequency components. The frequency converter of the invention includes a frequency conversion unit that executes frequency mixing of an intermediate frequency signal and a local oscillator signal to convert the intermediate frequency signal into a high frequency signal corresponding to a transmission channel, and plural stage variable tuning filters connected in cascade to the output of the frequency conversion unit, which are each individually tuned to the high frequency signal corresponding to the transmission channel.

### BACKGROUND OF THE INVENTION

1. Field of the Invention

The present invention relates to a transmitter circuit for a cable television (CATV), specifically to a frequency converter for a cable television transmitter, which directly converts an intermediate frequency signal into a high frequency signal corresponding to a transmission channel, and uses a variable tuning filter of plural stages in order to select the high frequency signal corresponding to a transmission channel.

2. Description of the Related Art

When the frequency converter for a cable television transmitter converts the intermediate frequency signal into the high frequency signal corresponding to a transmission channel and outputs the result, it is generally required that the outputted high frequency signal corresponding to a transmission channel sufficiently eliminate spurious frequency components and have a high level of the carrier vs. noise (CN) ratio. In order to meet these requirements, in a conventional frequency converter for a cable television transmitter, as a filter that selects the high frequency signal corresponding to a transmission channel, a plural-stage array of narrow band fixed filters such as a surface acoustic wave (SAW) filter has been used for a desired narrow band filter. Or, the double conversion system has been employed which, after converting the intermediate frequency signal into a signal of a higher frequency than the high frequency signal corresponding to a transmission channel (hereunder, this is called the ultra high frequency signal), reconverts the ultra high frequency signal into the high frequency signal corresponding to a transmission channel.

FIG. 6 is a block diagram illustrating an example of the known frequency converter for a cable television transmitter, which employs the double conversion system.

As shown in FIG. 6, a head end 60 of this converter includes an intermediate frequency amplifier (IFAMP) 61, a first frequency mixer (MIX1) 62, a first local oscillator (L.OSC1) 63, a first filter (FL1) 64, an ultra high frequency amplifier (CRFAMP) 65, a second frequency mixer (MIX2) 66, a second local oscillator (L.OSC2) 67, a high frequency amplifier (RFAMP) 68, a second filter (FL2) 69, an input terminal intermediate frequency signal 70, and an output terminal high frequency signal 71.

And, the intermediate frequency amplifier 61 has the input terminal connected to the input terminal intermediate frequency signal 70, and has the output terminal connected to the first input terminal of the first frequency mixer (MIX1) 62. The first frequency mixer (MIX1) 62 has the second input terminal connected to the output terminal of the first local oscillator 63, and has the output terminal connected to the input terminal of the first filter 64. The first filter 64 has the output terminal connected to the input terminal of the ultra high frequency amplifier 65. The second frequency mixer 66 has the first input terminal connected to the output terminal of the ultra high frequency amplifier 65, has the second input terminal connected to the output terminal of the second local oscillator 67, and has the output terminal connected to the input terminal of the high frequency amplifier 68. The second filter 69 has the input terminal connected to the output terminal of the high frequency amplifier 68, and has the output terminal connected to the output terminal high frequency signal 71.

In this case, the first local oscillator 63 generates an ultra high frequency signal of the frequency band 1.256 GHz with respect to the intermediate frequency signal of 44 MHz, and the first frequency mixer 62 generates an ultra high frequency signal of the frequency band 1.3 GHz. And, the second local oscillator 67 generates the high frequency signal of a frequency corresponding to a transmission channel, and the second frequency mixer 66 generates the high frequency signal corresponding to a transmission channel of 50 MHz to 860 MHz.

The frequency converter for the known cable television transmitter having the foregoing configuration carries out the following operations.

The intermediate frequency signal (44 MHz) supplied to the input terminal intermediate frequency signal 70 is amplified to a specific level by the intermediate frequency amplifier 61, and is supplied to the first frequency mixer 62. The ultra high frequency signal (1.256 GHz band) outputted from the first local oscillator 63 is also supplied to the first frequency mixer 62. The first frequency mixer 62 upconverts the intermediate frequency signal into the ultra high frequency signal (1.3 GHz band) by the ultra high frequency signal (1.256 GHz band), and the acquired ultra high frequency signal (1.3 GHz band) is supplied to the first filter 64. The first filter 64 removes the spurious frequency components contained in the ultra high frequency signal (1.3 GHz band), and the result is supplied to the ultra high frequency amplifier 65. The ultra high frequency amplifier 65 amplifies the ultra high frequency signal (1.3 GHz band) to a specific level, and supplies the result to the second frequency mixer 66. The second local oscillator 67 generates a high frequency signal of a frequency corresponding to the selected transmission channel, and supplies the high frequency signal to the second frequency mixer 66. The second frequency mixer 66 downconverts the ultra high frequency signal (1.3 GHz band) into the high frequency signal (50 MHz to 860 MHz) corresponding to a transmission channel by the high frequency signal outputted from the second local oscillator 67. The acquired high frequency signal (50 MHz to 860 MHz) is amplified to a specific level by the high frequency amplifier 68, and the result is supplied to the second filter 69. The second filter 69 selects only the high frequency signal for the transmission channel selected among the high frequency signal (50 MHz to 860 MHz), and supplies it to the output terminal high frequency signal 71.

Now, the filter that selects the high frequency signal corresponding to a transmission channel in the double conversion system not adopted is required to have an extremely severe pass band characteristics in order to sufficiently remove the spurious frequency components adjacent to the high frequency signal corresponding to a transmission channel, and a filter having such a pass band characteristics has been difficult to obtain.

In contrast to this, the known frequency converter for a cable television transmitter first converts the intermediate frequency signal into the ultra high frequency signal higher than the high frequency signal corresponding to a transmission channel, and then converts the ultra high frequency signal into the high frequency signal corresponding to a transmission channel; that is, the known frequency converter adopts the so-called double conversion system. Therefore, the pass band characteristics required for the first filter64 that selects the ultra high frequency signal, and the pass band characteristics required for the second filter 69 that selects the high frequency signal corresponding to a transmission channel can be made less severe, which is advantageous.

Since the known frequency converter for a cable television transmitter adopts the double conversion system, it has the advantage that the pass band characteristics required for the first filter 64 and the pass band characteristics required for the second filter 69 can be made less severe. On the contrary, however, the frequency converter needs more stages to configure the cable television transmitter circuit and makes the whole configuration complicated, and it employs two frequency mixers, namely, the first frequency mixer 62 and the second frequency mixer 66 that significantly lower the output signal level, which accordingly deteriorates the carrier vs. noise (C/N) ratio. In addition, the first frequency mixer 62 and the second frequency mixer 66 generate more of spurious frequency components during the frequency mixing, and the frequency converter needs the first filter 64 and the second filter 69 that remove the spurious frequency components individually at each stage.

### SUMMARY OF THE INVENTION

The present invention has been made in view of these technical circumstances, and it is an object of the invention to provide a frequency converter for a cable television transmitter that achieves frequency conversion with one frequency mixer to simplify the total configuration, that prevents deterioration of the carrier vs. noise ratio, and that allows removal of spurious frequency components.

According to an aspect of the invention, the frequency converter for a cable television transmitter includes a frequency conversion unit that executes frequency mixing of an intermediate frequency signal and a local oscillator signal to convert the intermediate frequency signal into a high frequency signal corresponding to a transmission channel, and plural stage variable tuning filters connected in cascade to an output of the frequency conversion unit, each tuned to the high frequency signal corresponding to the transmission channel.

According to the configuration, the conversion of the intermediate frequency signal into the high frequency signal corresponding to a transmission channel uses only one frequency conversion unit, and the total configuration can be simplified accordingly; and the loss of the signal level in the frequency conversion unit is comparably low, whereby the deterioration of the carrier vs. noise ratio can be restricted. And, since the selection of the high frequency signal corresponding to a transmission channel uses the plural stage variable tuning filters connected in cascade that are tuned to the high frequency signal corresponding to a transmission channel, the total pass band characteristics can be made substantially severe without setting each pass band characteristics of the variable tuning filters very severe, and the spurious frequency components can effectively be removed.

Further, the plural stage variable tuning filters in the invention preferably includes at least one of the variable tuning filters equipped with a trap circuit that removes the local oscillator signal.

When the local oscillator signal as well as the high frequency signal corresponding to a transmission channel is applied to the variable tuning filter having the trap circuit that removes the local oscillator signal, this configuration will completely trap a comparably high level local oscillator signal by the trap circuit that removes the local oscillator signal, and will not give an output from the variable tuning filter. Accordingly, the local oscillator signal will not cause influence over the high frequency signal corresponding to a transmission channel, which prevents deterioration of the carrier vs. noise ratio, and generation of the spurious frequency components.

Further, the plural stage variable tuning filters in the invention are preferably configured in three stages.

This configuration will make the entire pass band characteristics of the three-stage variable tuning filters severe, without increasing the number of stages of the variable tuning filters very much.

Further, the plural stage variable tuning filters in the invention may be configured such that adjustment voltages from pass band adjusting means can independently adjust these pass band characteristics.

When there are slight dispersions among the pass band characteristics of the plural stage variable tuning filters, this configuration will allow an individual fine adjustment of these pass band characteristics, and will make the pass band characteristics of the plural stage variable tuning filters almost coincident to make the entire pass band characteristics substantially severe.

The pass band adjusting means in the foregoing configuration is made up with a memory that stores the pass band characteristics of the plural stage variable tuning filters, and a digital to analog converter that generates a dc adjustment voltage based on a pass band characteristic read from the memory.

This configuration will store each of the pass band characteristics of the plural stage variable tuning filters in the memory in advance, will read each of the pass band characteristics as required, and will generate a dc adjustment voltage to make the pass band characteristics of the plural stage variable tuning filters substantially coincident, when generating the dc adjustment voltage based on the pass band characteristics read out. Accordingly, the pass band characteristics of the plural stage variable tuning filters can be made almost coincident automatically, so that the total pass band characteristics can be made substantially severe.

### BRIEF DESCRIPTION OF THE DRAWINGS

FIG. 1 illustrates a configuration of a frequency converter for a cable television transmitter of the embodiment according to the invention;

FIG. 2 is a circuit diagram illustrating a configuration of a variable tuning filter equipped with a trap circuit that removes the local oscillator signal;

FIG. 3 is a characteristics chart that comparably illustrates the total and the individual pass band characteristics by the first through the third variable tuning filters in the frequency converter for a cable television transmitter shown in FIG. 1;

FIG. 4A illustrates an example of the individual pass band characteristics of the first through the third variable tuning filters, and

FIG. 4B illustrates an example of the total pass band characteristics thereof,

FIG. 5 is a block diagram illustrating an example of a configuration of a pass band characteristics adjusting means that makes the signal level in the total pass band characteristics by the plural variable tuning filters substantially constant within the band; and

FIG. 6 is a block diagram illustrating an example of a configuration of the known frequency converter for a cable television transmitter.

### DETAILED DESCRIPTION OF THE PREFERRED EMBODIMENTS

The preferred embodiments of the invention will now be described with reference to the accompanying drawings.

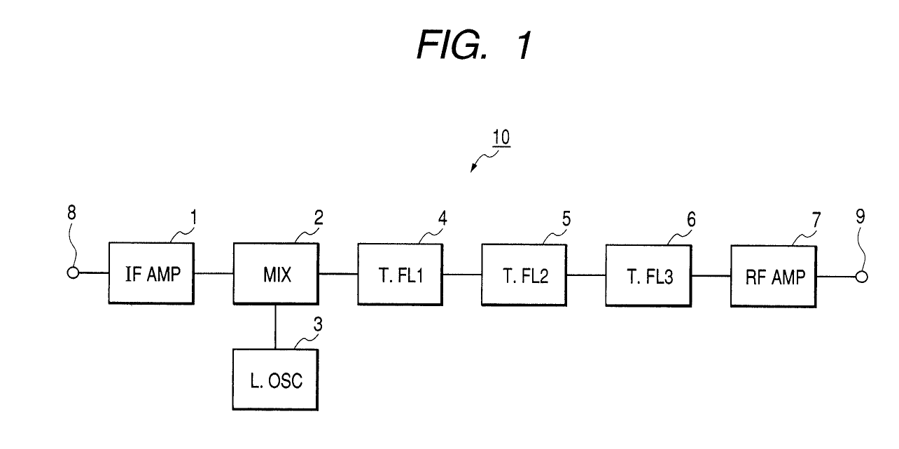

FIG. 1 illustrates a configuration of a frequency converter for a cable television transmitter of the embodiment according to the invention.

As shown in FIG. 1, a frequency converter 10 for a cable television of the embodiment includes an intermediate frequency amplifier (IFAMP) 1, a frequency mixer (MIX) 2, a local oscillator (L.OSC) 3, a first variable tuning filter (T.FL1) 4, a second variable tuning filter (T.FL2) 5, a third variable tuning filter (T.FL3) 6, a high frequency amplifier (RFAMP) 7, an input terminal intermediate frequency signal 8, and an output terminal high frequency signal 9.

The intermediate frequency amplifier 1 has the input terminal connected to the input terminal intermediate frequency signal 8, and has the output terminal connected to the first input terminal of the frequency mixer 2. The frequency mixer 2 has the second input terminal connected to the output terminal of the local oscillator 3, and has the output terminal connected to the input terminal of the first variable tuning filter 4. The second variable tuning filter 5 has the input terminal connected to the output terminal of the first variable tuning filter 4, and has the output terminal connected to the input terminal of the third variable tuning filter 6. The high frequency amplifier 7 has the input terminal connected to the output terminal of the third variable tuning filter 6, and has the output terminal connected to the output terminal high frequency signal 9.

Now, the local oscillator 3 generates a signal of a high frequency corresponding to a transmission channel, and makes the frequency mixer 2 generate a high frequency signal corresponding to a transmission channel covering the frequencies of 50 MHz through 860 MHz. The first variable tuning filter 4, the second variable tuning filter 5, and the third variable tuning filter 6 are each provided with voltage-variable capacitors (varactor diodes) inside the tuning circuits. Each time the high frequency signal corresponding to a transmission channel is selected, the tuning voltage is supplied to the corresponding voltage variable capacitor from a control unit not illustrated. Thus, the voltage-variable capacitors serve to tune each of the tuning circuits to the high frequency signal corresponding to a transmission channel.

The frequency converter 10 for a cable television transmitter of the embodiment provided with the foregoing configuration exhibits the following operation.

The intermediate frequency signal (44 MHz) supplied to the input terminal intermediate frequency signal 8 is amplified to a specific level by the intermediate frequency amplifier 1, and is supplied to the frequency mixer 2. The high frequency local oscillator signal outputted from the local oscillator 3, corresponding to the high frequency signal corresponding to a transmission channel, is supplied to the frequency mixer 2 as well. The frequency mixer 2 up converts the intermediate frequency signal with the high frequency local oscillator signal, and generates the high frequency signal corresponding to a transmission channel. The generated high frequency signal corresponding to a transmission channel is supplied to the first variable tuning filter 4. At this moment, the first variable tuning filter 4, the second variable tuning filter 5, and the third variable tuning filter 6 have the voltage-variable capacitors supplied with the tuning voltages from the control unit not illustrated, as mentioned above. Thus, the tuning circuits of the first variable tuning filter 4, the second variable tuning filter 5, and the third variable tuning filter 6 are made to tune to the high frequency signal corresponding to a transmission channel. Accordingly, first the high frequency signal corresponding to a transmission channel outputted from the frequency mixer 2 is filtered by the first variable tuning filter 4, next the high frequency signal filtered by the first variable tuning filter 4 is again filtered by the second variable tuning filter 5, and then the high frequency signal filtered by the second variable tuning filter 5 is again filtered by the third variable tuning filter 6. And, the high frequency signal corresponding to a transmission channel outputted from the third variable tuning filter 6 is supplied to the high frequency amplifier 7 in which the high frequency signal is amplified to a specific level and outputted to the output terminal high frequency signal 9.

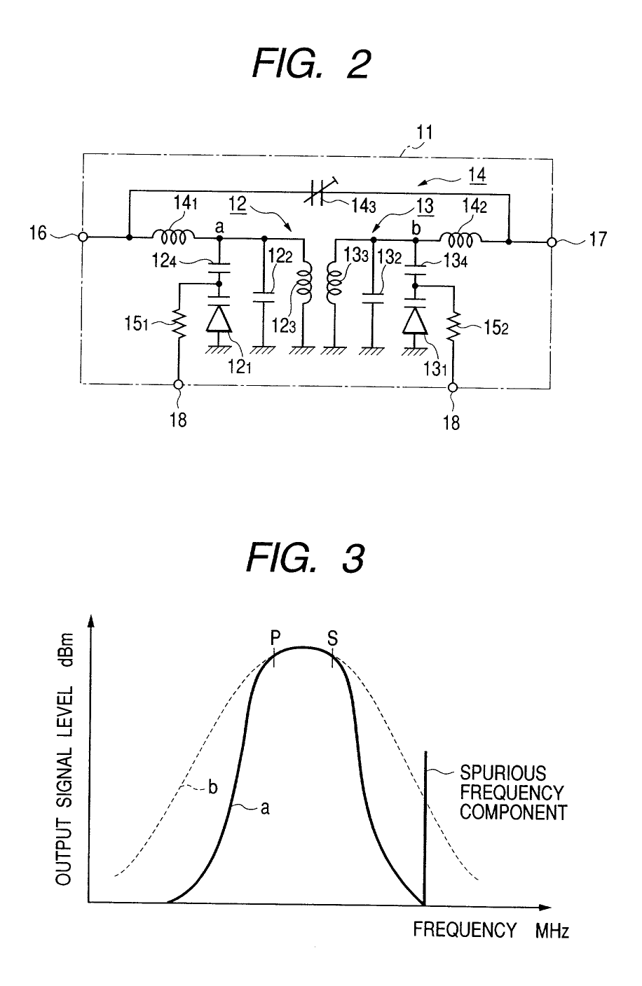

And, FIG. 2 illustrates a configuration of a variable tuning filter 11 equipped with a trap circuit that removes the local oscillator signal, and the variable tuning filter 11 is to be used in at least one of the first variable tuning filter 4, the second variable tuning filter 5, and the third variable tuning filter 6.

As shown in FIG. 2, the variable tuning filter 11 equipped with a trap circuit that removes the local oscillator signal includes a first varactor diode (voltage-variable capacitor) 12₁, a first capacitor 12₂, a first inductor 12₃, a second capacitor 12₄, a second varactor diode (voltage-variable capacitor) 13₁, a third capacitor 13₂, a second inductor 13₃, a fourth capacitor 13₄, a third inductor 14₁, a fourth inductor 14₂, a semi-fixed capacitor 14₃, a first buffer resistor 15₁, a second buffer resistor 15₂, a signal input terminal 16, a signal output terminal 17, and a tuning voltage supply input 18. Here, the first varactor diode 12₁, the first capacitor 12₂, the first inductor 12₃, and the second capacitor 12₄ make up the first tuning circuit 12; the second varactor diode 13₁, the third capacitor 13₂, the second inductor 13₃, and the fourth capacitor 13₄ make up the second tuning circuit 13; and the third inductor 14₁, the fourth inductor 14₂, and the semi-fixed capacitor 14₃ make up the trap circuit 14 that removes the local oscillator signal.

And, in the first tuning circuit 12, the cathode of the first varactor diode 12₁ is connected to a common node a through the second capacitor 12₄ and to the tuning voltage supply terminal 18 through the first buffer resistor 15₁, and the anode thereof is grounded. One end of the first capacitor 12₂ is connected to the common node a, and the other end thereof is grounded. One end of the first inductor 12₃ is connected to the common node a, and the other end thereof is grounded. In the second tuning circuit 13, the cathode of the second varactor diode 13₁ is connected to a common node b through the fourth capacitor 13₄ and to the tuning voltage supply terminal 18 through the second buffer resistor 15₂, and the anode thereof is grounded. One end of the third capacitor 13₂ is connected to the common node b, and the other end thereof is grounded. One end of the second inductor 13₃ is connected to the common node b, and the other end thereof is grounded. In this case, the first inductor 123 and the second inductor 13₃ are in inductive coupling, and thereby the first tuning circuit 12 and the second tuning circuit 13 are coupled through the first inductor 12₃ and the second inductor 13₃. And, in the trap circuit 14, one end of the third inductor 14₁ is connected to the common node a, and the other end thereof is connected to the signal input terminal 16. One end of the fourth inductor 14₂ is connected to the common node b, and the other end thereof is connected to the signal output terminal 17. One end of the semi-fixed capacitor 14₃ is connected to the signal input terminal 16, and the other end thereof is connected to the signal output terminal 17.

In the variable tuning filter 11 with the above configuration, as the tuning voltages are applied each to the tuning voltage supply terminal 18 on the side of the first tuning circuit 12 and to the tuning voltage supply terminal 18 on the side of the second tuning circuit 13, these tuning voltages are supplied to the first varactor diode 12₁ and to the second varactor diode 13₁. Thereby, the capacitances of the first varactor diode 12₁ and the second varactor diode 13₁ are each adjusted, and the first tuning circuit 12 and the second tuning circuit 13 are tuned to the high frequency signal corresponding to the selected transmission channel.

Here, as the high frequency signal corresponding to the selected transmission channel is supplied to the signal input terminal 16, the mutually coupled first tuning circuit 12 and second tuning circuit 13 that are tuned to the frequency of the high frequency signal corresponding to the selected transmission channel select only the high frequency signal components at the frequency; and thereafter, the high frequency signal corresponding to the selected transmission channel is supplied to the signal output terminal 17. On the other hand, the trap circuit 14 that is tuned to the frequency of the local oscillator signal obstructs the transmission of the local oscillator signal that is supplied to the signal input terminal 16 together with the high frequency signal corresponding to the selected transmission channel, and the local oscillator signal is not transmitted to the signal output terminal 17. Consequently, the signal components outputted from the signal output terminal 17 are only the signal components of the high frequency signal corresponding to the selected transmission channel, which do not contain the signal components of the local oscillator signal.

Further, in using the plural variable tuning filters, the variable tuning filter 11 equipped with the trap circuit 14 that removes the local oscillator signal may be applied to all the variable tuning filters, or may be applied at least to one of them. The variable tuning filter 11 with the semi-fixed capacitor 143 removed is a variable tuning filter without the trap circuit that removes the local oscillator signal.

Next, FIG. 3 is a characteristics chart that illustrates the total and the individual pass band characteristics by the first variable tuning filter 4, the second variable tuning filter 5, and the third variable tuning filter 6 in the frequency converter 10 for a cable television transmitter shown in FIG. 1.

In FIG. 3, the horizontal axis represents the frequency in MHz, and the vertical axis represent the output signal level in dBm.

As shown by a curve a in FIG. 3, in the overall pass b a n d characteristics by the first variable tuning filter 4, the second variable tuning filter 5, and the third variable tuning filter 6, the falling-down curve becomes sharp, and the overall pass band characteristics is able to eliminate almost completely the spurious frequency components which correspond to the adjacent channel to the transmission channel. On the other hand, as shown by a curve b in FIG. 3, in the overall pass band characteristics by any one of the first variable tuning filter 4, the second variable tuning filter 5, and the third variable tuning filter 6, the falling-down curve becomes gradual, and many of the spurious frequency components which correspond to the adjacent channel to the transmission channel remain. That is, the three-stage configuration by the first variable tuning filter 4, the second variable tuning filter 5, and the third variable tuning filter 6 exhibits a synergistic effect to produce the sharp falling-down characteristics, as shown by the curve a.

Now, as the first variable tuning filter 4, the second variable tuning filter 5, and the third variable tuning filter 6, as are shown in FIG. 1, when the first variable tuning filter 4, the second variable tuning filter 5, and the third variable tuning filter 6 are cascaded in three stages, even though the adjustment is made so that the tuning frequencies of the first tuning circuit 12 and the second tuning circuit 13 in the first variable tuning filter 4, the second variable tuning filter 5, and the third variable tuning filter 6 become equal, there can often occur slight discrepancies in each of the pass band characteristics of the first variable tuning filter 4, the second variable tuning filter 5, and the third variable tuning filter 6. And, when there occur slight discrepancies in the pass band characteristics of the first variable tuning filter 4, the second variable tuning filter 5, and the third variable tuning filter 6, the peak area of the overall pass band characteristics, that is, the signal level within the pass band becomes uneven; and accordingly, there occur slight differences in the signal level within the pass band, depending on the frequencies.

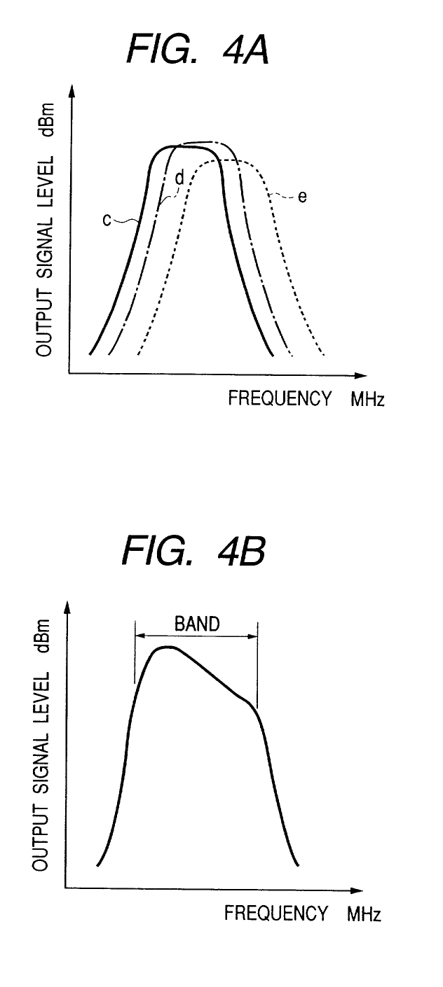

FIG. 4A illustrates an example of the individual pass band characteristics of the first variable tuning filter 4, the second variable tuning filter 5, and the third variable tuning filter 6, and FIG. 4B illustrates an example of the overall pass band characteristics of those filters.

In FIG. 4A, FIG. 4B, the horizontal axis represents the frequency in MHz, and the vertical axis represent the output signal level in dBm. In FIG. 4A, the curve c represents the pass band characteristics of the first variable tuning filter 4, the curve d represents the pass band characteristics of the second variable tuning filter 5, and the curve e represents the pass band characteristics of the third variable tuning filter 6.

As shown in FIG. 4A, although the first variable tuning filter 4, the second variable tuning filter 5, and the third variable tuning filter 6 are adjusted such that each of them are tuned to the same frequency, there are slight differences in the pass band characteristics as shown by the curve c, curve d, and curve e. In addition, when the signal level within the pass band of the curve e slightly differs from those of the curve c and the curve d, the overall pass band characteristics of the first variable tuning filter 4, the second variable tuning filter 5, and the third variable tuning filter 6 does not become almost constant in the signal level within the pass band but becomes uneven, as shown in FIG. 4B.

Accordingly in this invention, when the signal level in the overall pass band characteristics of the first variable tuning filter 4, the second variable tuning filter 5, and the third variable tuning filter 6 does not become almost constant within the pass band, in the stage of the test adjustment of the frequency converter for a cable television transmitter immediately after production, each of the pass band characteristics of the first variable tuning filter 4, the second variable tuning filter 5, and the third variable tuning filter 6 is individually measured by several points each with a pass band characteristics adjusting means; and on the basis of the measurement results, the adjustment voltages are to be generated individually which control the signal level in the overall pass band characteristics to be almost constant within the pass band. And, in using the frequency converter for a cable television transmitter, the adjustment voltages outputted from the pass band characteristics adjusting means are supplied to the first variable tuning filter 4, the second variable tuning filter 5, and the third variable tuning filter 6, so that the signal level in the overall pass band characteristics becomes substantially constant within the pass band.

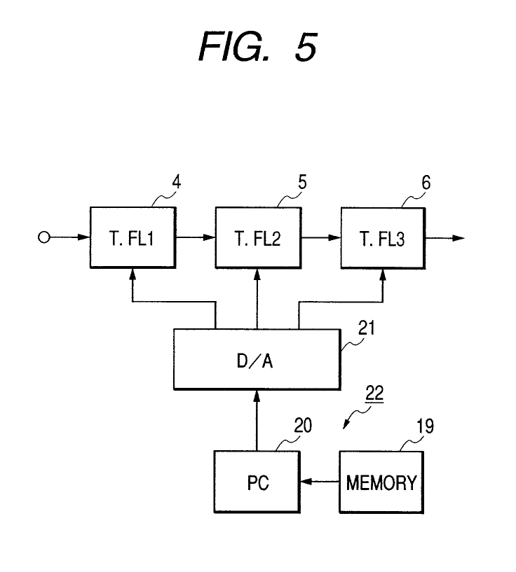

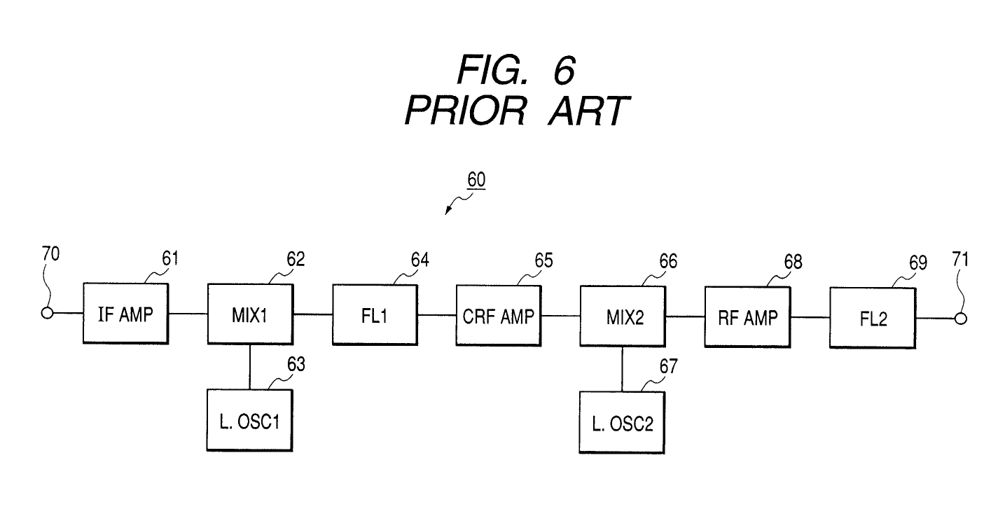

FIG. 5 illustrates an example of a configuration of the pass band characteristics adjusting means that generate such adjustment voltages.

As shown in FIG. 5, a pass band characteristics adjusting means 22 includes a flash memory 19, a control unit (PC) 20 configured with a microprocessor IC and the like, and a digital to analog (D/A) converter 21. In FIG. 5, the same components as those in FIG. 1 are given the same symbols.

Here, the flash memory 19 is coupled selectively with the control unit 20, and stores the measurement results in which the pass band characteristics of the first variable tuning filter 4, the second variable tuning filter 5, and the third variable tuning filter 6 are each measured at several points each. The control unit 20 reads the measurement results from the flash memory 19, generates controlling digital signals based on the measurement results, and supplies them to the digital to analog converter 21. The digital to analog converter 21 converts the supplied controlling digital signals into controlling analog voltages, and supplies the controlling analog voltages in correspondence to the first variable tuning filter 4, the second variable tuning filter 5, and the third variable tuning filter 6.

The pass band characteristics adjusting means 22 operates as follows.

In the stage of the test adjustment of the frequency converter 10 for a cable television transmitter immediately after production, a frequency characteristics measuring instrument not illustrated measures each of the pass band characteristics of the first variable tuning filter 4, the second variable tuning filter 5, and the third variable tuning filter 6 separately. Here, first the frequency characteristics measuring instrument measures the signal levels at predetermined several points, for example, at four points on the pass band characteristics of the first variable tuning filter 4, and stores the measurement results (hereunder, called measurement results 1) in the flash memory 19. Next, the measuring instrument measures the signal levels at the predetermined several points, for example, at four points on the pass band characteristics of the second variable tuning filter 5, and stores the measurement results (hereunder, called measurement results 2) in the flash memory 19; and then the measuring instrument measures the signal levels at the predetermined several points, for example, at four points on the pass band characteristics of the third variable tuning filter 6, and stores the measurement results (hereunder, called measurement results 3) in the flash memory 19.

Thereafter, when the frequency converter 10 for a cable television transmitter is shipped and is actually used, the control unit 20 reads the measurement results 1, the measurement results 2, and the measurement results 3 which are stored in the flash memory 19, and generates three controlling digital signals for making each of the pass band characteristics of the first variable tuning filter 4, the second variable tuning filter 5, and the third variable tuning filter 6 virtually equal on the basis of the measurement results 1, measurement results 2, and measurement results 3 read out; that is, the control unit 20 generates a controlling digital signal for the first variable tuning filter 4, a controlling digital signal for the second variable tuning filter 5, and a controlling digital signal for the third variable tuning filter 6, and supplies these controlling digital signals to the digital to analog converter 21. The digital to analog converter 21 converts the controlling digital signal for the first variable tuning filter 4 into a controlling analog voltage and supplies the controlling analog voltage to the first variable tuning filter 4, converts the controlling digital signal for the second variable tuning filter 5 into a controlling analog voltage and supplies the controlling analog voltage to the second variable tuning filter 5, and converts the controlling digital signal for the third variable tuning filter 6 into a controlling analog voltage and supplies the controlling analog voltage to the third variable tuning filter 6.

As the result, in the frequency converter 10 for a cable television transmitter, the pass band characteristics of the first variable tuning filter 4, the second variable tuning filter 5, and the third variable tuning filter 6 are brought into a substantial equivalence, and the signal level in the overall pass band characteristics by these tuning filters can be made almost constant within the pass band.

Further, in the aforementioned embodiment, the variable tuning filters are assumed such that the first variable tuning filter 4, the second variable tuning filter 5, and the third variable tuning filter 6 are cascaded in three stages. Although the number of the stages is preferably three, it is not limited to three; and as long as it is plural, it may be two, four or more than four.

As the invention having been described, since only one frequency conversion unit is employed for the conversion of the intermediate frequency signal into the high frequency signal corresponding to a transmission channel, the total configuration can be simplified; and the loss of the signal level in the frequency conversion unit can be restricted comparably low, and thereby the deterioration of the carrier vs. noise ratio can be minimized. And, since the plural stage variable tuning filters connected in cascade that are tuned to the high frequency signal corresponding to a transmission channel are used for the selection of the high frequency signal corresponding to a transmission channel, the entire pass band characteristics can substantially be made severe without setting each pass band characteristics of the variable tuning filters very severe, and the spurious frequency components can be effectively removed.

What is claimed is:

1. A frequency converter for a cable television transmitter, comprising: a frequency conversion unit that executes frequency mixing of an intermediate frequency signal and a local oscillator signal to convert into a high frequency signal corresponding to a transmission channel, and plural stage variable tuning filters connected in cascade to an output of the frequency conversion unit, each tuned to the high frequency signal corresponding to the transmission channel.

2. A frequency converter for a cable television transmitter according to claim 1, wherein at least one of the plural variable tuning filters is equipped with a trap circuit that removes the local oscillator signal.

3. A frequency converter for a cable television transmitter, according to claim 1, wherein the plural stage variable tuning filters are configured in three stages.

4. A frequency converter for a cable television transmitter according to claim 1, wherein the plural stage variable tuning filters are configured such that adjustment voltages from pass band adjusting means independently adjust the p as s band characteristics.

5. A frequency converter for a cable television transmitter according to claim 4, wherein the pass band adjusting means includes a memory that stores the pass band characteristics of the plural stage variable tuning filters, and a digital to analog converter that generates a dc adjustment voltage based on a pass band characteristic read from the memory.
